(19) United States
(12) Patent Application Publication
(10) Pub. No.: US 2026/0212314 A1
(43) Pub. Date: Jul. 23, 2026

(54) PORT-TO-INLAND FREIGHT OPERATIONS SUPPORT SYSTEM WITH BOUNDED FORECAST TIMING DURING PEAK CONGESTION

(71) Applicant: YUNSEOP IM, suwon (KR)

(72) Inventor: YUNSEOP IM, suwon (KR)

(21) Appl. No.: 19/561,614

(22) Filed: Mar. 10, 2026

(51) Int. Cl. G06Q 10/083; G06Q 10/067

(52) U.S. Cl. CPC G06Q 10/0843; G06Q 10/0674

(57) ABSTRACT

A computer-implemented system and method provide operations support for port-to-inland freight networks during peak congestion. The system constructs a directed freight graph partitioned into topology-constrained partitions satisfying predetermined node and link limits. At each simulation interval, the system commits a forward-only immutable snapshot and updates each partition under exclusive write authority. Cross-partition effects are scheduled only for future intervals, enforcing forward causal ordering without rollback. Per-interval work is structurally bounded by partition count and partition limits, independent of transient freight arrival volume. Operational outputs comprising rail departure delay profiles, corridor travel time estimates, rerouting recommendations, and capacity reallocation indicators are delivered within predetermined operational deadlines. In one embodiment, vessel call schedule or AIS data injects time-indexed demand shocks at seaport nodes prior to partition updates. In one embodiment, a dwell time compliance monitor generates violation alerts when projected freight dwell time is forecast to exceed applicable regulatory or contractual thresholds.

### CROSS-REFERENCE TO RELATED APPLICATIONS

This application claims priority to U.S. Provisional Patent Application No. 63/988,044, filed Feb. 22, 2026, the entire contents of which are incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### SEQUENCE LISTING

Not applicable.

### FIELD OF THE INVENTION

The present disclosure relates to computer-implemented systems and methods for port-to-inland freight operations support. More particularly, the disclosure relates to a structure-bounded deterministic execution architecture for generating congestion propagation forecasts and operational decision outputs in port-to-inland freight networks using topology-constrained partitions and forward-only simulation interval snapshots.

In certain embodiments, the disclosed execution engine structurally bounds per-interval computation by enforcing partition size limits, exclusive write authority, and forward-only snapshot progression, thereby enabling delivery of forecast outputs within predetermined operational deadlines during peak congestion.

### BACKGROUND OF THE INVENTION

Port-to-inland freight logistics networks encompass seaport container terminals, rail intermodal terminals, inland depots, and associated rail and road freight corridors. Accurate and computationally predictable simulation of congestion propagation across such networks is of considerable importance for infrastructure planning, operations management, and real-time decision support.

Conventional logistics simulation systems commonly employ discrete-event simulation (DES) techniques in which event lists are processed in time order. Distributed DES variants may utilize synchronization or rollback mechanisms to preserve causality. A fundamental characteristic of such event-driven approaches is that computational workload scales with transient event volume: in periods of severe congestion, the number of discrete events increases, resulting in increased computational cost per simulation interval.

This variable computational burden presents a significant problem for systems that must provide real-time or near-real-time operational support. During peak congestion events, port authorities, terminal operators, rail carriers, and inland depot operators may require updated congestion forecasts within a predetermined operational decision cycle (e.g., minutes to tens of minutes) to support actions such as dynamic rerouting, rail departure slot planning, and capacity reallocation. When congestion is highest and situational awareness is most critical, existing event-driven systems exhibit increased computational cost due to their event-volume-dependent execution. Moreover, event-driven systems do not structurally guarantee worst-case computational cost per simulation interval, presenting challenges for time-critical decision support applications.

A further limitation of existing systems is the use of rollback mechanisms in distributed simulation. Rollback-capable systems require maintenance of historical state and introduce non-deterministic execution paths, complicating verification and reproducibility.

### RELATED ART

### Category 1: Logistics Network Simulation

WO 2022/266827 A1 (Logistics Network Simulation Method and System) discloses a method for simulating a large-scale logistics network by modeling logistics operations as a sequence of discrete logistics events processed in chronological order. The system represents logistics nodes and routes within a network topology and updates network state in response to time-ordered logistics events. While WO 2022/266827 A1 addresses large-scale logistics simulation using event sequencing, it does not disclose an execution architecture in which a directed logistics graph is partitioned into topology-constrained bounded partitions with predetermined node and link limits, nor does it disclose forward-only snapshot progression with exclusive write authority enforcement or structural worst-case per-interval computational bounding independent of event volume.

U.S. Pat. No. 10,216,183 B2 (3D Intelligent Scheduling Method Based on Logistics Simulation Software) discloses a logistics control system in which real-world AGV events trigger 3D simulation processing, and simulation results are converted into control signals for physical equipment. Although U.S. Pat. No. 10,216,183 B2 describes an event-driven simulation framework integrated with physical logistics equipment, it does not disclose a structure-bounded deterministic execution architecture, topology-constrained graph partitioning with strict node and link bounds, forward-only simulation interval snapshots without rollback, or structural computational cost bounding independent of transient logistics event volume.

### Category 2: Digital Twin and Distributed Event-Discrete Systems

EP 3 726 305 A1/U.S. Pat. No. 11,562,113 B2 (Process Control with Digital Twins) disclose digital twin-based modeling of distributed event-discrete systems. The system clusters subsystems into digital twin objects and processes streaming events across defined topologies for real-time control and monitoring. While these references describe distributed event processing and subsystem clustering, they do not disclose topology-constrained bounded partition construction with fixed structural limits (Nmax, Lmax), exclusive write authority per partition per simulation interval, forward-only snapshot progression prohibiting rollback, or structural worst-case per-interval computational bounding independent of event magnitude.

### Category 3: General Discrete Event Simulation Frameworks

U.S. Patent Application Publication No. 2021/0209271 A1 (Flexible Discrete Event Simulator) discloses a modular discrete event simulation framework in which multiple event modules process entities via event queues, supporting Monte Carlo analysis and statistical evaluation. Although US 2021/0209271 A1 describes a flexible event-queue-based DES architecture applicable to transportation and logistics domains, it does not disclose a structure-bounded deterministic execution architecture in which a logistics graph is partitioned into topology-constrained bounded partitions, forward-only simulation interval snapshots are enforced without rollback, exclusive write authority is guaranteed per partition, and worst-case per-interval update operations are bounded as a structural function independent of transient event volume.

Accordingly, the above references, considered individually or in combination, do not disclose or suggest a structure-bounded deterministic execution architecture in which:
1. A logistics graph is partitioned into topology-constrained partitions satisfying strict node and link bounds;
2. Network state is maintained as a strictly monotonic sequence of committed simulation interval snapshots that progress only forward in time and that prohibit rollback, and cross-partition state effects are scheduled only for application in future simulation intervals;
3. Exclusive write authority is enforced per partition per simulation interval such that exactly one execution context is permitted to modify node state and link state within a given partition during a given simulation interval; and
4. Worst-case per-interval update operations are structurally bounded by a function of partition count and the strict node and link bounds, remaining independent of transient freight event volume.

The present disclosure addresses the foregoing limitations by providing a deterministic, forward-only, partitioned execution architecture with a structural worst-case cost bound.

### SUMMARY OF THE INVENTION

The present disclosure provides a freight operations support system for port-to-inland freight corridors that enables bounded delivery of congestion propagation forecasts within predetermined operational deadlines during peak congestion periods. In one embodiment, the system includes a structure-bounded deterministic execution architecture that partitions a directed graph representation of the freight network into topology-constrained partitions satisfying predetermined node and link count bounds, maintains network state as a sequence of forward-only simulation interval snapshots, enforces exclusive write authority per partition per simulation interval, and constrains worst-case per-interval update operations to a bound that is a function of the structural partition parameters and is independent of transient freight arrival volume. The architecture addresses the technical problem of unpredictable computational slowdown in conventional discrete-event simulation systems during high-congestion periods. By structurally bounding worst-case per-interval operations independent of transient freight arrival volume, the disclosed system provides predictable execution time suitable for time-critical congestion forecasting, dynamic rerouting support, capacity planning, and operational decision-making in port-to-inland freight networks.

In a first aspect, the present disclosure provides a computer-implemented method for structure-bounded deterministic execution of a port-to-inland freight congestion propagation simulation, the method comprising: constructing, by one or more processors, a directed freight network graph comprising at least one seaport freight terminal node, a plurality of inland freight nodes including rail intermodal terminals and inland depots, and a plurality of directed freight corridor links; partitioning the directed freight network graph into a plurality of topology-constrained partitions using a breadth-first search (BFS)-based partitioning algorithm, wherein a candidate node is accepted into a current partition only if: (i) inclusion of the candidate node does not cause a partition node count to exceed a predetermined maximum node bound Nmax, and (ii) inclusion of outgoing links of the candidate node does not cause a partition link count to exceed a predetermined maximum link bound Lmax, such that each node and each directed link is assigned to exactly one partition, and wherein a candidate node that fails the acceptance conditions is deferred to a subsequent partition without being marked as visited; assigning exclusive write authority to exactly one execution context per partition per simulation interval; maintaining network state as a strictly monotonic forward-only sequence of committed immutable simulation interval snapshots; scheduling cross-partition state effects such that each effect generated during processing of a simulation interval t is assigned an apply_time strictly greater than t; bounding worst-case per-interval update operations to a structural bound that is a function of (i) a total number of partitions and (ii) Nmax and Lmax and is independent of transient freight arrival volume; generating, from each committed snapshot, one or more operational outputs comprising at least one of a rail departure delay profile, a corridor travel time estimate, a node congestion metric, or a rerouting recommendation signal; and delivering the one or more operational outputs within a predetermined operational deadline during peak congestion.

In a second aspect, the present disclosure provides a system for freight operations support and structure-bounded deterministic simulation of congestion propagation in a port-to-inland freight network, the system comprising one or more processors and one or more non-transitory computer-readable storage media storing instructions that, when executed by the one or more processors, cause the processors to construct a directed freight network graph, partition the graph into topology-constrained partitions satisfying predetermined Nmax and Lmax bounds, assign exclusive write authority to exactly one execution context per partition per simulation interval, maintain network state as a strictly monotonic forward-only sequence of committed immutable simulation interval snapshots, schedule all cross-partition state effects with apply_time strictly greater than the current simulation interval, enforce a structural worst-case bound on per-interval update operations that is a function of partition count and the Nmax and Lmax bounds and remains independent of transient freight arrival volume, generate one or more operational outputs from committed snapshots, and enforce delivery of the one or more operational outputs within predetermined operational deadlines during peak congestion.

In a third aspect, the present disclosure provides a non-transitory computer-readable storage medium storing instructions that, when executed by one or more processors, implement a structure-bounded deterministic freight operations support engine enforcing five structural invariants: (I1) forward-only immutable committed simulation interval snapshots prohibiting rollback and prohibiting application of cross-partition effects in the same simulation interval in which they are generated; (I2) topology-constrained bounded partitions satisfying predetermined Nmax and Lmax per partition; (I3) complete partition coverage guaranteeing every node and directed link is assigned to exactly one partition; (I4) exclusive write authority assigning exactly one execution context per partition per simulation interval; and (I5) structural independence of worst-case per-interval update operations from transient freight arrival volume, thereby enabling delivery of congestion forecast outputs within predetermined operational deadlines during peak congestion.

The foregoing aspects and advantages of the present disclosure will become apparent from the following detailed description, considered in connection with the accompanying drawings.

The accompanying drawings illustrate exemplary embodiments of the present disclosure and are described below.

The disclosed execution architecture improves computer functionality by reducing inter-partition synchronization overhead, eliminating rollback-related state storage, minimizing shared mutable memory contention, and enforcing a deterministic upper bound on instruction execution per simulation interval. These structural constraints modify the manner in which processors schedule and execute update operations, thereby constituting an improvement to computer operation rather than a mere mathematical calculation. In conventional event-driven simulation architectures, a per-interval structural cost bound that is independent of transient freight arrival volume is not suggested by eliminating rollback-driven state re-execution, constraining partition topology, or preventing cross-partition concurrent mutation in isolation. The present architecture achieves this bound through the structural co-enforcement of all five invariants (I1-I5), a combination that is not disclosed by the prior-art references considered herein.

### BRIEF DESCRIPTION OF THE DRAWINGS

FIG. 1 illustrates the overall structure-bounded deterministic simulation system (100), comprising a freight network data input (101), a topology-constrained partitioning module (102), a forward-only snapshot state manager (103), an exclusive write authority enforcer (104), a combined committed snapshot S(t+1) and structural cost bound output (105), a time-bucketed effect scheduler (106), parallel execution contexts (107), and a deterministic merge step (108). Invariant labels I1-I5, including I3: Coverage guarantee, are shown adjacent to corresponding modules, according to an embodiment.

FIG. 2 illustrates the topology-constrained partition structure (200), showing directed graph G(V, E) (201) partitioned into topology-constrained partitions (202-206), with nodes (209) interconnected by intra-partition links (207) and cross-partition links (208), wherein each partition satisfies predetermined maximum node count Nmax and maximum link count Lmax, according to an embodiment.

FIG. 3 illustrates the partition construction algorithm as a pseudocode listing, including initialization of a global queue with seaport root nodes, BFS-based partition seeding, node acceptance subject to bounds Nmax and Lmax, deferral of non-fitting nodes to the global queue, and assertion of complete coverage upon completion, according to an embodiment.

FIG. 4 illustrates the forward-only simulation interval snapshot sequence (400), showing snapshots S(t−1) (402), S(t) (403), S(t+1) (404), and S(t+2) (405) advancing along time axis (401) via commit steps (406), with cross-partition effects (407) scheduled strictly at future intervals and backward modification (408) prohibited, with partition updates executed in parallel swim lanes (409), one per partition, according to an embodiment.

FIG. 5 illustrates the exclusive write authority assignment per partition per simulation interval (500), showing committed snapshot S(t) (501) provided as input to interval scheduler (502), which assigns each partition to a dedicated execution context (503, 504, 505) operating under an exclusive write lock (507), writing to a partition-local buffer (506), with a deterministic merge step (508) producing the next committed snapshot S(t+1) (509), according to an embodiment.

FIG. 6 illustrates an operational dashboard or interface that presents congestion forecast outputs, including rail departure delay profile values, corridor travel time estimate values, dynamic rerouting recommendation signals, and capacity alert indicators, according to an embodiment.

FIG. 7 illustrates exemplary structural cost-bound verification in which, for tested arrival volumes A_k from 50 to 50,000,000 events per interval, per-interval update operations remain constant at 1,807,136 and runtime remains within a narrow band with a mean of approximately 365.9 ms, according to an embodiment.

FIG. 8 illustrates the vessel call schedule and AIS demand injection architecture (800), showing a port authority vessel scheduling system (801) and AIS transponder data stream (802) as dual input sources, a vessel schedule parser (803) extracting vessel identifier, ETA, cargo volume, and berth identifier tuples, an interval-to-time mapper (804) converting ETA to simulation interval index, a time-indexed demand injection schedule (805), a demand injection gate (806) enforcing the I1 structural constraint that injection precedes partition update commencement, a seaport terminal root node (807) receiving the demand shock, and a forward-only snapshot (808) through which the demand shock propagates while preserving structural invariants I1 through I5, according to an embodiment.

FIG. 9 illustrates the dwell time compliance monitor architecture (900), showing a committed snapshot trajectory (901) of immutable SHA-256-digested snapshots, a dwell time tracker (902) computing cumulative dwell time per node across committed snapshots, a node-type threshold registry (903) storing per-node-type thresholds fixed at simulation initialization to ensure deterministic compliance evaluation across committed snapshots, a compliance comparator (904) projecting dwell time against thresholds over a forecast horizon, a compliance indicator (905) for nodes within threshold, an alert pipeline (906) for nodes projected to breach threshold, a dwell violation alert (907) comprising node identifier, estimated breach interval, and corrective action, a corrective action selector (908) routing to capacity reallocation (909), rerouting recommendation (910), or regulatory notification (911) outputs, and an operational output (912) incorporating dwell alerts within the predetermined deadline, auditable via SHA-256 snapshot digests enforced by Invariants I1 and I4, according to an embodiment.

The accompanying drawings, which form a part of this specification, illustrate embodiments of the present disclosure and, together with the description, serve to explain the principles of the invention. In the drawings, reference numerals designate identical or corresponding parts throughout the several views of the drawings. The embodiments described herein are illustrative and are not intended to limit the scope of the claims.

### DETAILED DESCRIPTION OF EMBODIMENTS

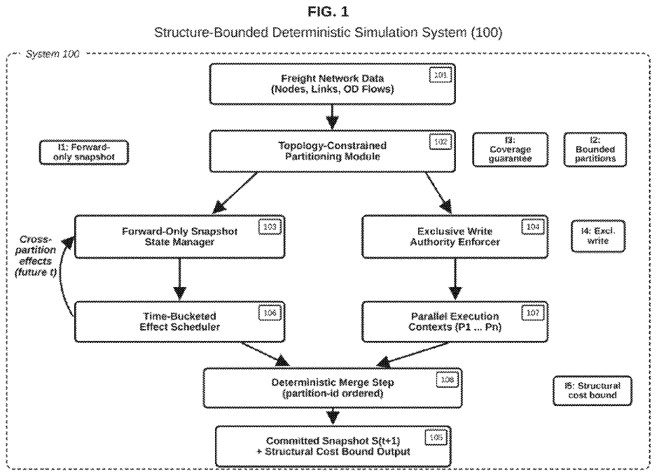

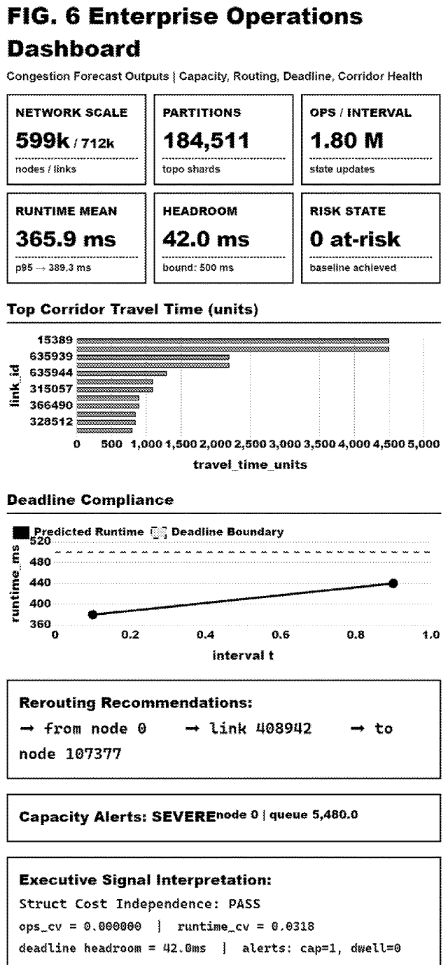

Referring to FIG. 1, the structure-bounded deterministic simulation system (100) receives freight network data at input (101) and processes it through a topology-constrained partitioning module (102), a forward-only snapshot state manager (103), an exclusive write authority enforcer (104), and a time-bucketed effect scheduler (106). Parallel execution contexts (107) update partition-local state under exclusive write authority, and a deterministic merge step (108) produces the committed snapshot S(t+1) together with the structural cost bound, both available at output (105). In one embodiment, the system further derives operational outputs (e.g., rail departure delay profile values, corridor travel time estimate values, dynamic rerouting recommendation signals, and capacity alert indicators) from the committed snapshots and delivers the operational outputs within a predetermined operational deadline for use in time-critical freight operations support, as further illustrated in FIG. 6. The following detailed description is presented to enable any person skilled in the art to make and use the invention. For purposes of explanation, specific details are set forth to provide a thorough understanding of the present disclosure. However, these specific details are not required to practice the invention. Descriptions of specific applications and methods are provided only as examples. Various modifications to the preferred embodiments will be readily apparent to those skilled in the art, and the general principles defined herein may be applied to other embodiments and applications without departing from the spirit and scope of the invention.

As used herein, the following terms have the following meanings:

“Simulation interval” means a discrete time unit of the simulation at which a network state snapshot is computed and committed.

“Per-interval update operations” means a total number of node state updates and link state updates executed during a single simulation interval. As used herein, “real-time operations support” means the delivery of operational outputs, including congestion forecasts and rerouting recommendations, within a predetermined operational deadline that is established prior to simulation execution and that is consistent with the decision cycle requirements of port-to-inland freight operations personnel, such as a deadline on the order of minutes to tens of minutes.

In one embodiment, multiple freight arrivals or congestion events occurring within a simulation interval are aggregated into node-level and link-level state variables prior to committing the next snapshot, such that per-interval update operations are performed at the granularity of nodes and directed links rather than at the granularity of individual freight-unit events.

“Directed graph G(V, E)” means a graph comprising a set V of nodes and a set E of directed links, wherein each directed link has a source node and a destination node within V.

“Topology-constrained partition” means a subset of nodes and their associated outgoing links from the directed graph, satisfying a predetermined maximum node count Nmax and a predetermined maximum link count Lmax.

In one embodiment, each directed link is assigned to the topology-constrained partition that contains the source node of the directed link, such that link-to-partition assignment is unambiguous for coverage validation and effect scheduling.

“Forward-only snapshot” means a complete record of network state at a simulation interval, wherein simulation time progresses only forward from S(t) to S(t+1), each committed snapshot is immutable after commitment, and subsequent operations reference prior snapshots as read-only input.

“Exclusive write authority” means the assignment of exactly one execution context as the sole entity permitted to modify node and link states within a given partition during a given simulation interval.

“Structural cost bound” means a worst-case upper bound on per-interval update operations that is a function of partition count P and the partition size limits Nmax and Lmax, and that does not scale with transient freight event multiplicity (i.e., a number of freight units or congestion events occurring per simulation interval).

In one embodiment, the system and method described herein are implemented in a deterministic, structure-bounded execution engine in the Rust programming language. The implementation executed on a full-scale port-to-inland freight graph derived from the FAF5 (Freight Analysis Framework version 5) dataset comprising 599,081 nodes, 712,870 directed links, and partitioned into 184,511 topology-constrained partitions with Nmax=15 and Lmax=25.

### 1. Network Representation

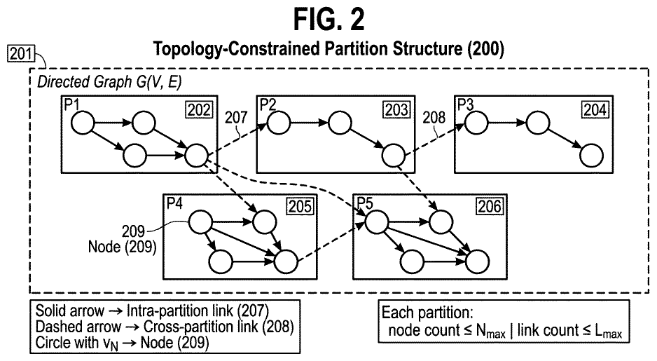

Referring to FIG. 2, the logistics network is represented as a directed graph G(V, E) (201), comprising: at least one seaport freight terminal node; a plurality of inland freight nodes (209) including rail intermodal terminals and inland depots; and rail and road freight links forming directed freight flows between nodes, represented as intra-partition links (207) within partitions and cross-partition links (208) between partitions.

In one embodiment, each node in the graph corresponds to a physical facility or junction within the port-to-inland freight network. Each directed link represents a freight corridor, with associated capacity and nominal transit time attributes. Node state comprises at minimum a congestion occupancy value maintained as a fixed-point integer representation (e.g., scaled by a factor of 1000 to preserve precision without floating-point non-determinism).

In one embodiment, the graph is constructed from freight network data sources including FAF5 processed network files, NTAD (National Transportation Atlas Database) facility files, and port throughput indicator data, yielding a unified multi-modal directed graph covering road, rail, and port connector segments.

### 2. Topology-Constrained Partitioning (Invariant I2 and I3)

As shown in FIG. 2, the directed graph G(V, E) (201) is partitioned into a plurality of topology-constrained partitions P={P_1, P_2, . . . , P_p} (202-206) using a breadth-first search (BFS)-based partitioning algorithm. Each partition satisfies node count<=Nmax and link count<=Lmax. In one embodiment, the BFS-based partitioning algorithm is seeded from one or more seaport terminal nodes as root nodes. Cross-partition links (208) represent state effects that are deferred to future simulation intervals.

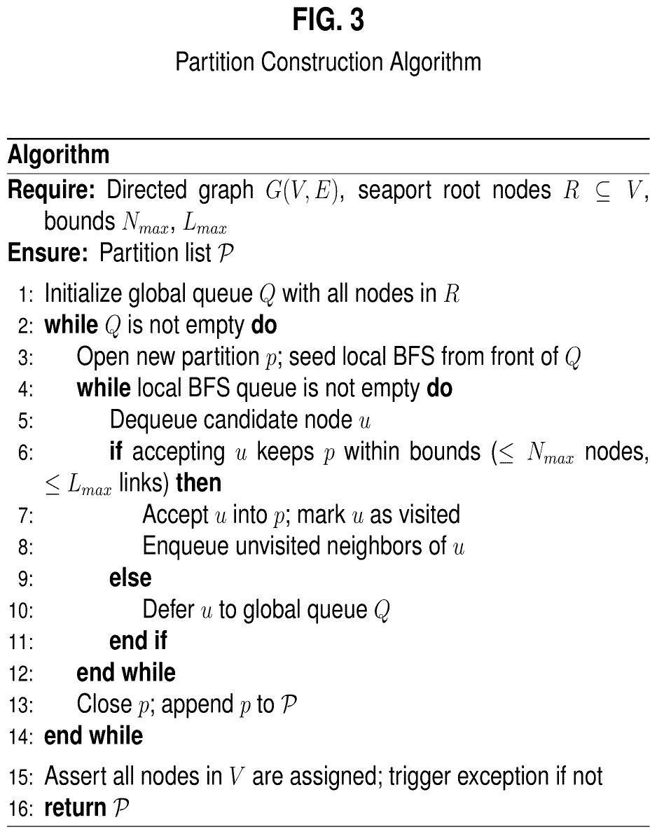

The partition construction algorithm, illustrated in FIG. 3, operates as follows:
(a) A global queue is initialized with one or more deterministic root node identifiers. In one embodiment for port-to-inland freight networks, the root node identifiers comprise seaport terminal nodes. If no seaport roots exist or are specified, the first unvisited node is used as the initial seed.
(b) A new partition is opened. A BFS proceeds from the seed node. For each candidate node u dequeued from the local BFS queue:
(i) The node u is accepted into the current partition only if the following acceptance conditions are both satisfied: (1) the current partition node count plus one does not exceed Nmax; and (2) the current partition link count plus the out-degree of node u (i.e., the number of outgoing links from u) does not exceed Lmax. This ensures that any accepted node and all of its outgoing links are fully accommodated within the current partition's bounds.
(ii) If the acceptance conditions are not met, node u is deferred to a future partition. Crucially, node u is not marked as visited until after successful acceptance, preventing premature exclusion from future retry.
(iii) Upon acceptance, node u is marked visited, assigned to the current partition, and its outgoing links are assigned to the current partition.
(c) When the local BFS queue is exhausted without filling the partition, or when partition bounds are reached, the current partition is closed and a new partition is opened. The global queue is replenished from the set of as-yet-unvisited nodes.
(d) The process continues until all nodes have been visited and assigned.
(e) Upon completion, coverage validation is performed, verifying: (1) every node is assigned to exactly one partition; (2) every directed link is assigned to exactly one partition; (3) no partition exceeds Nmax nodes or Lmax links; and (4) no node or link is assigned to more than one partition. If any validation condition is not satisfied, execution terminates and an error is returned.

This partitioning enforces Invariant I2 (bounded partitions: |V_p|<=Nmax and |E_p|<=Lmax for all partitions p) and Invariant I3 (coverage guarantee: every node and every directed link is assigned to exactly one partition).

### 3. Forward-Only Snapshot State Management (Invariant I1)

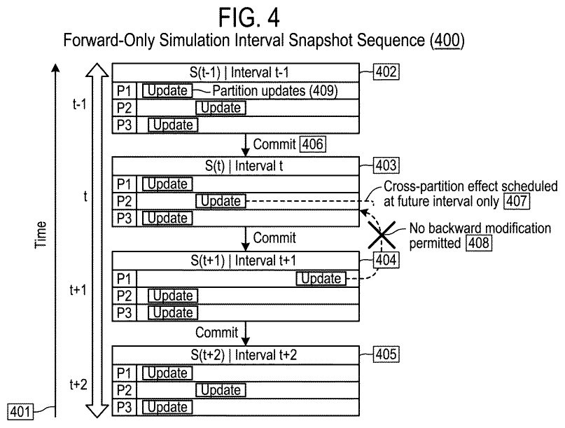

Referring to FIG. 4, the simulation engine maintains a sequence of network state snapshots S(t−1) (402), S(t) (403), S(t+1) (404), and S(t+2) (405), advancing along time axis (401) at each simulation interval. Each snapshot records the complete node and link state of the freight network at the corresponding simulation interval. Partition updates for each interval are executed independently across parallel swim lanes (409), one per partition.

As shown in FIG. 4, state progression is strictly forward-only: at each simulation interval t, a new snapshot S(t+1) is constructed from S(t) by applying scheduled cross-partition effects and partition-local updates via commit step (406). Once S(t) is committed, it is immutable and is not modified in subsequent intervals, and no execution context operates on a prior-interval snapshot after commitment.

Cross-partition effects (i.e., state changes generated within one partition that affect nodes or links in another partition) are explicitly assigned an apply_time strictly greater than the current simulation interval t, as depicted by element (407) in FIG. 4. That is, a cross-partition effect generated during processing of interval t is assigned apply_time=t+1 or later. Effects with apply_time<=t are strictly prohibited. This forward-scheduling of cross-partition effects enforces causality without rollback.

The foregoing enforces Invariant I1 (forward-only immutable snapshot progression), as illustrated in FIG. 4.

### 4. Exclusive Write Authority (Invariant I4)

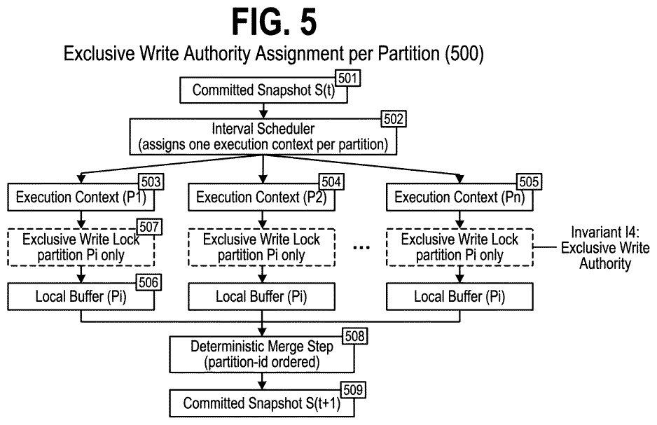

Referring to FIG. 5, committed snapshot S(t) (501) is provided as input to interval scheduler (502), which, for each simulation interval t, assigns each partition to exactly one execution context (503, 504, 505). No other execution context is permitted to modify node states or link states within that partition during interval t.

As shown in FIG. 5, the exclusive write authority is implemented via partition-local buffers (506): each execution context operates under an exclusive write lock (507) and maintains a local copy of the node and link state updates for its assigned partition during interval t. After all partitions have completed their local updates, deterministic merge step (508) combines all partition-local buffers into the new committed snapshot S(t+1) (509). The merge step processes partitions in deterministic partition-id order to ensure reproducibility.

Parallel execution contexts (503, 504, 505) (implemented, in one embodiment, using a data-parallelism library providing thread-pool-based parallel iteration) update partition-local buffers (506) concurrently under exclusive write locks (507), with no shared mutable state between execution contexts during the update phase. This design enforces Invariant I4 (exclusive write authority: each partition is updated by one execution context per interval) while enabling parallel throughput, as illustrated in FIG. 5.

### 5. Structural Cost Bound (Invariant I5)

The worst-case per-interval update operations are bounded by the structural parameters of the partition set, as expressed by:

$$Ops\_max ( t ) <= K * P * ( N max + L max )$$

where P is the number of partitions, Nmax is the maximum node count per partition, Lmax is the maximum link count per partition, and K is an implementation-dependent constant factor that remains fixed for a given implementation and hardware configuration throughout simulation execution and does not vary with transient freight arrival volume. In one embodiment, K is determined at system initialization based on the number of state variables per node and per link and the fixed computational cost of a single node or link state update operation, and is bounded above by a value that depends only on implementation and hardware characteristics, not on runtime event multiplicity.

This bound is a function of the static topology of the partition set and does not scale with transient freight event multiplicity during a given simulation interval.

In one embodiment, experiments on the full-scale FAF5-derived graph (599,081 nodes, 712,870 directed links, 184,511 partitions, Nmax=15, Lmax=25) observed that per-interval update operations remained fixed at 1,807,136 across tested arrival volumes A_k selected from {50, 500, 5,000, 50,000, 500,000, 5,000,000, 50,000,000}, while measured runtime values were 369 ms, 366 ms, 374 ms, 356 ms, 353 ms, 355 ms, and 388 ms, respectively, yielding a mean runtime of approximately 365.9 ms and a runtime coefficient of variation of approximately 0.03179 for the tested configuration.

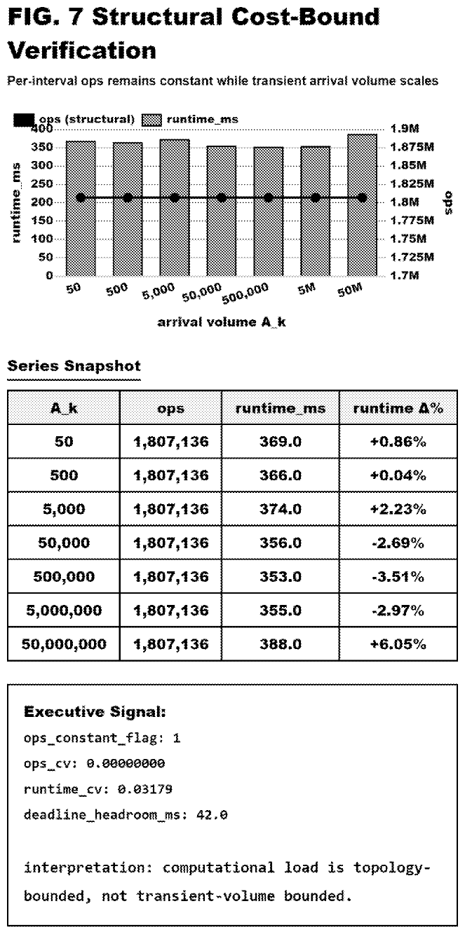

This enforces Invariant I5 (structural cost independence: per-interval update operations per interval are independent of arrival magnitude). Unlike conventional event-driven simulation frameworks where computational cost scales with transient event volume and may cause latency that exceeds predetermined operational deadlines during peak congestion, the present architecture enforces a deterministic structural bound on per-interval operations as a function of partition count and partition size limits. This technical improvement enhances computer functionality by providing predictable execution time and enabling time-critical congestion forecasting, dynamic rerouting support, capacity planning, and operational decision support across physical port-to-inland logistics corridors. The bounded, deterministic execution time allows stakeholders to rely on simulation results for timely operational decisions, such as rerouting freight flows or adjusting terminal capacity, during peak congestion periods where conventional systems may exceed operational deadline requirements. In one embodiment, the operational outputs are presented via an operational dashboard or interface as illustrated in FIG. 6, and the bounded-runtime behavior enabling delivery within predetermined operational deadlines is illustrated by an exemplary performance comparison as illustrated in FIG. 7.

Comparative Performance Analysis. FIG. 7 illustrates structural cost-bound verification for the FAF5-derived test network (599,081 nodes, 712,870 directed links, 184,511 partitions) under tested arrival volumes ranging from 50 to 50,000,000 events per interval. In the illustrated configuration, the disclosed architecture maintained fixed per-interval update operations of 1,807,136 across the tested arrival volumes and maintained runtime within a 353 ms to 388 ms band, with a mean runtime of approximately 365.9 ms, a runtime coefficient of variation of approximately 0.03179, and deadline headroom of approximately 42.0 ms in the tested configuration. These observations are consistent with the volume-independent structural bound of Invariant I5, are illustrative, and do not limit the scope of the claimed invention. This performance behavior is consistent with the structural enforcement of forward-only snapshot immutability, topology-constrained partitioning, and exclusive write authority.

The structural cost bound of Invariant I5 is realized by the combined enforcement of Invariants I1 through I4. Forward-only immutable snapshot progression (I1) eliminates rollback-related state mutation that can amplify writes and introduce non-deterministic execution paths. Topology-constrained partition limits and complete coverage (I2 and I3) ensure that per-interval work remains a function of bounded partition structure rather than unbounded growth of a single partition. Exclusive write authority (I4) prevents concurrent cross-context modification within a partition, reducing shared mutable state contention. Deferred scheduling of cross-partition effects to strictly future intervals constrains cascading propagation within an interval. Accordingly, I5 should be understood as a structural consequence of simultaneously enforcing I1-I4 rather than as an optimization applied in isolation. I5 does not arise from any proper subset of I1-I4: omitting forward-only snapshot progression (I1) reintroduces rollback amplification; relaxing partition bounds (I2 or I3) permits unbounded per-interval growth; and permitting concurrent write authority (I4) reintroduces non-deterministic contention paths. Each of I1 through I4 is structurally required for I5, and the prior-art references considered herein do not suggest a combination that produces the structural bound through concurrent enforcement of all four constraints within the same execution architecture.

### 6. Determinism and Reproducibility

The simulation engine is designed to produce identical output for identical inputs across repeated executions. Determinism is achieved through:
(a) Fixed-point integer state representation (i64 with scale factor 1000), eliminating floating-point non-determinism;
(b) Deterministic ordering of all data structures accessed during simulation, including partition-local buffer processing and effect scheduling queues;
(c) Deterministic merge ordering using partition-id sort; and
(d) Deterministic SHA-256 snapshot digest computation at each interval for verification, wherein the digest is computed over a serialized representation of node congestion occupancy values and link state values in the committed snapshot.

In one embodiment, snapshot state is serialized in a deterministic order defined by ascending partition identifiers and ascending node identifiers within each partition prior to digest computation, thereby ensuring reproducible digest values across independent executions on identical inputs.

In one embodiment, two independent execution runs of the simulation with identical input parameters were observed to produce identical SHA-256 snapshot digests at every simulation interval in tested configurations, consistent with the deterministic execution guarantees of Invariants I1 through I4.

### 7. Effect Scheduler

Cross-partition state effects are managed by a time-bucketed effect scheduler. When a node update in partition p generates a state effect intended for a node in a different partition p′, the effect is assigned an apply_time strictly greater than the current interval t (e.g., apply_time=t+1 for road-speed propagation; apply_time=t+2 for rail-segment propagation). Effects are stored in simulation interval buckets and applied at the beginning of the corresponding future simulation interval, prior to partition-local updates for that interval.

In one embodiment, apply_time offsets may reflect modal operating characteristics of the freight network. For example, road corridor effects may be scheduled for application at t+1 to reflect near-continuous flow propagation, while rail corridor effects may be scheduled at t+2 or later to reflect slot-based departure cycles. Such offsets are exemplary and are not required, provided that apply_time is strictly greater than the current interval t.

The effect scheduler enforces the forward-only invariant: at no point during simulation interval t is an effect with apply_time<=t generated or applied. This constraint is validated at runtime during both effect generation and effect application.

### 8. Exemplary Implementation

In one embodiment, the simulation engine is implemented in the Rust programming language with the following modules:

graph.rs: directed graph and node/link types, JSON/JSONL loader for graph_nodes.jsonl and graph_links.jsonl, synthetic graph generator for test execution.

model.rs: fixed-point state types (NodeState, LinkState), simulation interval snapshot structure, demand profile, scheduled effect type, and per-interval metrics struct.

partition.rs: topology-constrained partition construction algorithm (build_partitions_coverage ( )), node-to-partition and link-to-partition mapping arrays, and coverage validation.

engine.rs: forward-only simulation loop, time-bucketed effect scheduler, parallel partition-local buffer update, deterministic merge, per-interval instrumentation, I1-I5 invariant evaluation, and SHA-256 snapshot digest computation; ops.rs: operational output generation and formatting (delay profiles, travel time estimates, rerouting recommendation signals, and capacity alerts); and deadline.rs: a forecast deadline manager estimating completion time from the structural cost bound and adjusting execution scheduling to satisfy predetermined operational deadlines.

main.rs: command-line interface providing —prepare-input (deterministic DB ETL), —experiment (I5 cost-independence verification), —fig5-benchmark (structural cost sweep over multiple arrival volumes), —verify-determinism (two-run hash comparison), and —report (full invariant and metrics report).

In one embodiment, the implementation executed on a graph of 599,081 nodes and 712,870 directed links derived from the FAF5 Freight Analysis Framework dataset, partitioned into 184,511 partitions with Nmax=15 and Lmax=25. All five invariants (I1 through I5) were observed to hold, and determinism was confirmed by matching snapshot digests across runs.

### 9. Alternative Embodiments

In alternative embodiments, the partition bounds Nmax and Lmax may be configured to values different from the exemplary Nmax=15 and Lmax=25 values described herein, depending on the memory and parallelism constraints of the target computing environment.

In alternative embodiments, the simulation engine may be implemented in computing environments other than the Rust programming language, including C++, Java, or other compiled or interpreted languages, provided that the five structural invariants (I1-I5) are maintained by the implementation.

In alternative embodiments, the logistics network may encompass freight networks other than port-to-inland freight, including inter-regional road freight networks, national rail freight networks, or multi-modal international freight corridors, provided that the network is representable as a directed graph amenable to topology-constrained partitioning.

In alternative embodiments, cross-partition effect apply_time offsets may vary from the exemplary t+1 and t+2 values described herein, provided that the apply_time is strictly greater than the current simulation interval t, preserving the forward-only invariant.

### 9A. Modal Offset Registry

In one embodiment, the time-bucketed effect scheduler maintains a modal offset registry that associates each freight corridor link type with a predetermined apply_time offset. The modal offset registry specifies, for each link type, an integer offset value strictly greater than zero that is added to the current simulation interval t to determine the apply_time of a cross-partition effect originating from a link of that type. In one embodiment, the modal offset registry stores the following default offset values: road freight corridor links are assigned an offset of one simulation interval, reflecting near-continuous vehicular flow propagation; rail freight corridor links are assigned an offset of two simulation intervals, reflecting train formation cycles and slot-based departure scheduling; port connector links are assigned an offset of one simulation interval; and intermodal transfer links are assigned an offset of three simulation intervals, reflecting multi-step transshipment latency. In alternative embodiments, offset values may be user-configured at system initialization, provided that each offset value remains strictly greater than zero to preserve the forward-only invariant (I1). The modal offset registry is fixed prior to simulation execution and does not change during the simulation run.

When a cross-partition effect is generated during processing of simulation interval t, the execution context queries the modal offset registry with the link type of the originating freight corridor link and retrieves the corresponding offset value d, and sets the effect apply_time to t plus d. This registry-driven offset assignment ensures that effect propagation latency reflects the physical operating characteristics of each freight mode, while maintaining the forward-only constraint that apply_time is strictly greater than t for all generated effects.

### 9B. Seaport-Distance Partition Rank

In one embodiment, each partition is assigned a seaport-distance rank during partition construction. The seaport-distance rank of a partition is defined as the minimum BFS hop count from the nearest seaport freight terminal root node to any node within the partition, computed over the directed freight network graph G(V, E). Partitions containing one or more seaport freight terminal nodes are assigned a seaport-distance rank of zero. Partitions containing no seaport freight terminal nodes are assigned a rank equal to the shortest directed-path hop count from any seaport root node to the nearest node in the partition. Where no directed path from any seaport root exists to a partition, the rank is assigned a maximum sentinel value.

In one embodiment, cross-partition effects are applied at the beginning of each simulation interval in ascending seaport-distance rank order. Effects targeting partitions with lower seaport-distance rank values are applied before effects targeting partitions with higher rank values. Where two or more target partitions share the same seaport-distance rank, effects are applied in ascending partition-identifier order to preserve determinism. This rank-ordered effect application enforces physical freight flow causality: congestion originating at a seaport terminal propagates outward to progressively more inland partitions in an order that mirrors the directed freight flow topology, without requiring inter-partition synchronization barriers beyond the time-bucketed effect scheduler already enforced by Invariant I1.

### 9C. Chained Snapshot Digest

In one embodiment, snapshot digest computation is structured as a chained digest sequence in which each committed snapshot digest is computed over a concatenation of: (i) a deterministically serialized representation of the current snapshot state S(t), comprising node congestion occupancy values and link state values in ascending partition-identifier and ascending node-identifier order; and (ii) the digest of the immediately preceding committed snapshot S(t−1). Formally, digest (t)=SHA256 (serialize (S(t))∥digest(t−1)), where ∥ denotes byte concatenation. The digest of the initial snapshot S(0) is computed as digest(0)=SHA256 (serialize(S(0))∥genesis_seed), where genesis_seed is a predetermined fixed byte sequence established at simulation initialization. This chained structure ensures that any modification to the state of any prior snapshot S(k) for k less than t produces a detectable divergence in digest (k) that propagates to all subsequent digests digest(k+1) through digest (t). Accordingly, two independent execution runs on identical inputs that produce identical digest(T) at the final interval T are guaranteed to have produced identical intermediate snapshot states at every simulation interval, providing a stronger determinism guarantee than independent per-interval digest comparison.

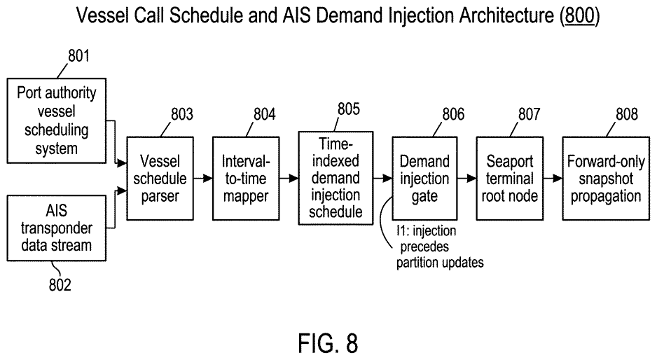

### 9D. Vessel Call Schedule Integration (FIG. 8)

In one embodiment, the simulation engine imports vessel call schedule data or Automatic Identification System (AIS) positional data associated with one or more vessels scheduled to arrive at a seaport freight terminal served by the freight network. For each scheduled vessel arrival, the simulation engine derives a time-indexed predicted arrival volume representing the estimated volume of freight units to be discharged at the corresponding seaport freight terminal node upon vessel berthing. The predicted arrival volume is injected as a demand shock at the seaport freight terminal root node (807) at the simulation interval corresponding to the estimated vessel arrival time, prior to beginning partition updates for that interval, as illustrated in FIG. 8. In one embodiment, the demand shock is computed as a function of vessel cargo manifest data, historical discharge rates for the vessel type, and terminal berth utilization state at the time of injection. In one exemplary implementation, the demand injection quantity is computed as the product of the cargo volume estimate in freight units and a discharge rate factor representing the fraction of cargo discharged per simulation interval, clipped to available node capacity. The injected demand shock propagates through the port-to-inland freight network graph via the forward-only simulation interval snapshot mechanism, enabling congestion propagation forecasts to reflect scheduled vessel traffic without requiring modification of the structural invariants I1 through I5. The vessel demand injection is architecturally required to occur prior to the commencement of partition updates for the corresponding simulation interval; injection after partition update commencement would introduce a mid-interval state mutation incompatible with the forward-only immutability requirement of Invariant I1. Accordingly, the demand injection step is not a separable add-on feature but a structurally constrained operation whose ordering and scope are determined by the simultaneous enforcement of I1 through I5.

In one embodiment, vessel call schedule data is obtained from a port authority vessel scheduling system or from AIS transponder data streams and is parsed to extract, for each scheduled vessel: a vessel identifier, an estimated time of arrival (ETA) at the destination seaport terminal, a cargo volume estimate expressed in freight units, and a terminal berth identifier corresponding to a seaport root node in the directed freight network graph. The simulation engine maps each (ETA, cargo volume, berth identifier) tuple to a (simulation interval index, demand injection quantity, seaport node identifier) tuple using a predetermined interval-to-time mapping. The resulting time-indexed demand injection schedule is applied at the corresponding seaport root nodes at the appropriate simulation intervals during the simulation run. This mapping preserves the forward-only invariant I1 because vessel arrival demand is injected only at simulation intervals corresponding to future estimated arrival times relative to the current simulation state.

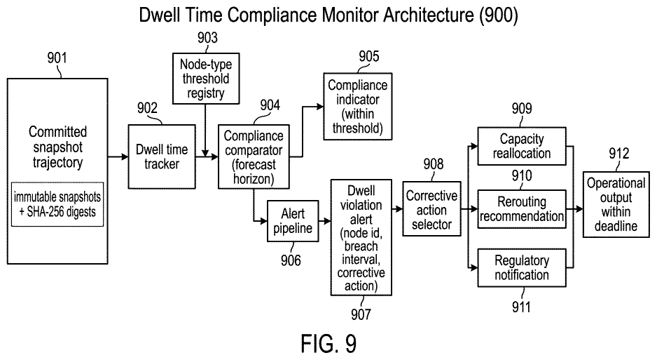

### 9E. Dwell Time Compliance Monitor (FIG. 9)

In one embodiment, each node in the directed freight network graph is associated with a dwell time compliance threshold representing a maximum permissible duration for which freight units may reside at that node without violating applicable regulatory or contractual requirements. In one embodiment, dwell time compliance thresholds are specified per node type: seaport terminal nodes may carry a threshold corresponding to customs or port authority free-time allowances; inland depot nodes may carry a threshold corresponding to carrier or shipper contractual free-time limits; and rail intermodal terminal nodes may carry a threshold corresponding to rail carrier free-time tariff provisions. The simulation engine tracks, at each committed simulation interval snapshot, an estimated cumulative dwell time for freight units at each node, derived from the node congestion occupancy state trajectory across committed snapshots, as illustrated in FIG. 9. In one exemplary implementation, the estimated cumulative dwell time at node v at simulation interval t is computed as the count of consecutive committed simulation intervals ending at t during which the congestion occupancy value at node v exceeded zero, multiplied by the simulation interval duration in time units.

The dwell time compliance monitor generates a dwell time compliance indicator for each node at each simulation interval. When the estimated cumulative dwell time at a node is projected to exceed the applicable dwell time compliance threshold within a predetermined forecast horizon, the compliance monitor generates a dwell time violation alert comprising a node identifier, the estimated time of threshold breach expressed as a simulation interval index, and a recommended corrective action selected from: a capacity reallocation recommendation directing freight units to an alternative node with available capacity within the dwell threshold; a rerouting recommendation directing incoming freight flows away from the congested node; and a regulatory notification signal for transmission to applicable port authority or customs authority systems. The dwell time violation alert is generated from committed snapshot state and is included in the operational outputs delivered within the predetermined operational deadline. Because the simulation engine produces deterministic committed snapshots with associated SHA-256 digests, the dwell time compliance trajectory is fully auditable and reproducible, enabling post-hoc regulatory compliance certification. The dwell time compliance monitor is structurally dependent on the committed snapshot architecture: it operates exclusively on immutable committed snapshots rather than on mutable in-progress state, a requirement imposed by Invariant I1 (forward-only immutable snapshots) and Invariant I4 (exclusive write authority). Operating on in-progress mutable state would introduce race conditions incompatible with I4 and would render the compliance audit trail non-reproducible. This structural dependency ensures that the compliance monitoring function is not independently combinable with prior-art simulation systems unless those systems also enforce I1 through I5 concurrently.

### 10. Computer-Readable Medium Embodiment

Embodiments of the present disclosure may include a system, a method, and/or a computer program product. The computer program product may include a computer-readable storage medium (or media) having computer-readable program instructions thereon for causing a processor to carry out aspects of the present invention as described herein.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing.

Computer-readable program instructions described herein can be downloaded to respective computing/processing devices from a computer-readable storage medium or to an external computer or external storage device via a network. The computer-readable program instructions may execute entirely on one or more user computers, partly on one or more user computers, as a standalone software package, or partly on one or more user computers and partly on a remote computer or entirely on a remote computer or server.

What is claimed is:

1. A computer-implemented method for real-time port-to-inland freight operations support during peak congestion periods, comprising:
constructing, by one or more processors, a directed freight network graph comprising seaport terminals, rail intermodal nodes, inland depots, and directed freight corridors;
for each simulation interval, aggregating multiple freight arrivals or congestion events into node-level and link-level state variables associated with the directed freight network graph;
partitioning the directed freight network graph into topology-constrained partitions using a breadth-first search (BFS)-based partitioning algorithm, wherein a candidate node is accepted into a current partition only if: (i) inclusion of the candidate node does not cause a partition node count to exceed a predetermined maximum node count Nmax, and (ii) inclusion of outgoing links of the candidate node does not cause a partition link count to exceed a predetermined maximum link count Lmax, such that each node and each directed link is assigned to exactly one partition, and wherein a candidate node that fails the acceptance conditions is deferred to a subsequent partition without being marked as visited;
maintaining network state as forward-only immutable committed simulation interval snapshots S(t), wherein simulation time progresses only forward and a committed snapshot is not modified after commitment;
scheduling cross-partition effects generated during processing of a simulation interval t for application only at an apply_time strictly greater than t;
enforcing exclusive write authority per partition per simulation interval by assigning exactly one execution context to update each partition during the simulation interval;
updating partition-local buffers in parallel from a committed snapshot S(t) to generate updated partition-local state for a subsequent committed snapshot S(t+1);
deterministically merging the updated partition-local state in partition-identifier order to commit S(t+1);
generating, from one or more committed snapshots, one or more operational outputs comprising at least one of: (i) a rail departure delay profile, (ii) a corridor travel time estimate, (iii) a node congestion metric, (iv) a dynamic rerouting recommendation signal, or (v) a capacity alert indicator; and
delivering the one or more operational outputs within a predetermined operational deadline during peak congestion;
wherein worst-case per-interval update operations are structurally bounded by a function of a total number of partitions and the predetermined maximum node count Nmax and predetermined maximum link count Lmax, remain independent of transient freight arrival volume, and are performed at the granularity of nodes and directed links rather than at the granularity of individual freight-unit events.

2. The method of claim 1, wherein the predetermined maximum node count Nmax and the predetermined maximum link count Lmax are each independently selected based on available memory and parallel execution capacity of a target computing platform such that a per-partition memory footprint does not exceed Nmax multiplied by s_node plus Lmax multiplied by s_link, where s_node is a fixed-point state size in bytes per node and s_link is a fixed-point state size in bytes per link, such that per-interval update operations remain structurally bounded independent of transient freight arrival volume.

3. The method of claim 1, wherein constructing the directed freight network graph comprises importing node data and directed freight corridor data from one or more freight network data sources, each node corresponding to a physical freight facility or junction and each directed freight corridor link having associated capacity and nominal transit time attributes.

4. The method of claim 1, wherein the predetermined operational deadline is established prior to simulation execution and remains fixed throughout a simulation run, and wherein the structural bound on per-interval update operations enables a predicted completion time for each simulation interval to be computed prior to beginning partition updates for that interval.

5. The method of claim 1, further comprising:
monitoring, by a forecast deadline manager, a predicted completion time for each simulation interval based on the structural bound; and
dynamically adjusting at least one of partition execution ordering and computing resource allocation when the predicted completion time indicates risk of missing the predetermined operational deadline.

6. A freight operations support system for port-to-inland freight networks, comprising:
one or more processors; and
memory storing instructions that, when executed by the one or more processors, cause the one or more processors to perform operations comprising:
constructing a directed freight network graph;
for each simulation interval, aggregating multiple freight arrivals or congestion events into node-level and link-level state variables associated with the directed freight network graph;
partitioning the directed freight network graph into topology-constrained partitions using a breadth-first search (BFS)-based partitioning algorithm, wherein a candidate node is accepted into a current partition only if: (i) inclusion of the candidate node does not cause a partition node count to exceed a predetermined maximum node count Nmax, and (ii) inclusion of outgoing links of the candidate node does not cause a partition link count to exceed a predetermined maximum link count Lmax, such that each node and each directed link is assigned to exactly one partition, and wherein a candidate node that fails the acceptance conditions is deferred to a subsequent partition without being marked as visited;
maintaining network state as forward-only immutable committed simulation interval snapshots;
scheduling cross-partition effects for application only at an apply_time strictly greater than a current simulation interval;
assigning exclusive write authority to exactly one execution context per partition per simulation interval to update partition-local buffers in parallel from a committed snapshot to generate updated partition-local state for a subsequent committed snapshot;
deterministically merging the updated partition-local state in partition-identifier order to commit the subsequent committed snapshot;
generating one or more operational outputs from one or more committed snapshots, the one or more operational outputs comprising at least one of a rail departure delay profile, a corridor travel time estimate, a node congestion metric, a dynamic rerouting recommendation signal, or a capacity alert indicator; and
enforcing delivery of the one or more operational outputs within a predetermined operational deadline during peak congestion;
wherein worst-case per-interval update operations are structurally bounded by a function of a total number of partitions and the predetermined maximum node count Nmax and predetermined maximum link count Lmax, remain independent of transient freight arrival volume, and are performed at the granularity of nodes and directed links rather than at the granularity of individual freight-unit events.

7. The system of claim 6, wherein the BFS traversal uses seaport terminals as root nodes for partition seeding.

8. The system of claim 6, wherein the instructions further cause the one or more processors to perform coverage validation verifying that: (i) every node is assigned to exactly one partition; (ii) every directed link is assigned to exactly one partition in accordance with a link-to-partition assignment rule; (iii) no partition contains more than Nmax nodes; and (iv) no partition contains more than Lmax links, and wherein the system terminates execution and returns an error if any coverage validation condition is not satisfied.

9. The system of claim 6, wherein the instructions further cause the one or more processors to maintain a time-bucketed effect scheduler that stores cross-partition effects indexed by apply_time, applies stored effects at a beginning of each corresponding future simulation interval prior to partition-local updates, and validates during both effect generation and effect application that no effect is assigned an apply_time less than or equal to the current simulation interval.

10. The system of claim 6, wherein node state is represented as a fixed-point integer value scaled by a predetermined factor to eliminate floating-point nondeterminism, and wherein the system computes a deterministic hash digest of each committed simulation interval snapshot to enable verification of identical outputs across independent execution runs on identical inputs.

11. The system of claim 6, wherein execution contexts update respective partition-local buffers concurrently with no shared mutable state during an update phase, and wherein after all partition-local updates are complete, a deterministic merge step combines partition-local buffers into a new committed snapshot by processing partitions in deterministic partition-identifier order.

12. The system of claim 6, wherein enforcing delivery of the operational outputs within the predetermined operational deadline comprises computing a predicted completion time from the structural bound and dynamically adjusting at least one of: (i) a partition execution order, (ii) a number of execution contexts, and (iii) resource allocations for at-risk simulation intervals.

13. The method of claim 1, wherein generating the one or more operational outputs comprises generating node congestion metric values and generating a capacity alert indicator when the node congestion metric values satisfy a congestion threshold condition.

14. The method of claim 1, further comprising transmitting the operational outputs to at least one of an operations dashboard, an alerting system, and an external operations support system via a network interface.

15. The method of claim 1, further comprising storing the operational outputs together with a snapshot digest associated with at least one committed snapshot to enable audit and reproducibility of operational decisions.

16. A non-transitory computer-readable storage medium storing instructions that, when executed by one or more processors, cause the one or more processors to perform the method of claim 1.

17. The method of claim 1, further comprising importing, prior to simulation execution, vessel call schedule data or Automatic Identification System (AIS) data associated with one or more vessels scheduled to arrive at a seaport freight terminal node in the directed freight network graph, deriving therefrom a time-indexed demand injection schedule associating each scheduled vessel arrival with a predicted freight arrival volume at the corresponding seaport freight terminal root node, and injecting the predicted freight arrival volume as a demand shock at the seaport freight terminal root node at the simulation interval corresponding to the estimated vessel arrival time, wherein the demand shock propagates through the directed freight network graph via the forward-only simulation interval snapshot mechanism without modifying the structural invariants governing per-interval update operation bounds.

18. The method of claim 17, wherein deriving the time-indexed demand injection schedule comprises parsing, for each scheduled vessel, a vessel identifier, an estimated time of arrival at a destination seaport terminal, a cargo volume estimate, and a terminal berth identifier corresponding to a seaport root node in the directed freight network graph, and mapping each estimated time of arrival to a simulation interval index using a predetermined interval-to-time mapping.

19. The method of claim 1, further comprising associating each node in the directed freight network graph with a dwell time compliance threshold representing a maximum permissible freight unit residence duration at that node, tracking an estimated cumulative dwell time for freight units at each node across committed simulation interval snapshots, and generating a dwell time compliance indicator for each node at each simulation interval, wherein when the estimated cumulative dwell time at a node is projected to exceed the dwell time compliance threshold within a predetermined forecast horizon, generating a dwell time violation alert comprising a node identifier, an estimated time of threshold breach, and a recommended corrective action selected from a capacity reallocation recommendation, a rerouting recommendation, and a regulatory notification signal.

20. The method of claim 19, wherein the dwell time compliance threshold is specified per node type, comprising a customs or port authority free-time allowance for seaport terminal nodes, a carrier or shipper contractual free-time limit for inland depot nodes, and a rail carrier free-time tariff provision for rail intermodal terminal nodes, and wherein the dwell time compliance trajectory across committed simulation interval snapshots is auditable and reproducible by virtue of the deterministic SHA-256 snapshot digests associated with each committed snapshot.
